(19) United States
(12) Patent Application Publication
(10) Pub. No.: US 2014/0297496 A1
(43) Pub. Date: Oct. 2, 2014

(54) GENERATING A PROBABILITY ADJUSTED DISCOUNT FOR LACK OF MARKETABILITY

(71) Applicant: Marc Vianello, Overland Park, KS (US)

(72) Inventor: Marc Vianello, Overland Park, KS (US)

(21) Appl. No.: 13/853,753

(22) Filed: Mar. 29, 2013

(51) Int. Cl. G06Q 40/00

(52) U.S. Cl. CPC G06Q 40/04
USPC 705/37

(57) ABSTRACT

A method, system, and medium are provided for generating a probability adjusted discount for lack of marketability (DLOM) for an asset to be valued. A user interface is provided to receive a selection of a number of parameters associated with the asset to be valued and to receive an estimated volatility for the asset's value. A selection of a database containing transaction data associated with previously closed asset sales can also be received. An adjusted mean and standard deviation for transaction periods associated with the selected parameters and the previously closed asset sales is determined. A statistical modeling application provides a log-normal probability distribution of the probability of closing a sale of the asset with respect to time. Time period-specific DLOMs are calculated, weighted based on the probabilities depicted by the distribution, and summed to provide the probability weighted DLOM, which is presented to the user via the user interface.

### BACKGROUND

The business valuation concept of marketability deals with the liquidity of the ownership interest. How quickly and certainly an owner can convert an investment to cash represent two very different variables. The “quickly” variable represents the period of time it will take the seller to liquidate an investment. This period of time can vary greatly depending on the standard of value in play. For example, liquidation sales can occur quickly and generally reflect lower prices, while orderly sales usually take longer to explore the marketplace of reasonable buyers and generally reflect greater than liquidation prices. In every instance, however, the “quickly” variable commences with a decision by the seller to initiate the sales process. The “certainty” variable represents the probability that the seller will realize the estimated sale price (value) of the investment. Therefore, the “certainty” variable represents the price volatility of the investment during the period of time that it is being offered for sale. If market prices for similar investments fall dramatically while the marketplace is being explored, then the seller will have lost the opportunity to lock in the higher price that existed at the time the sell decision was made. Conversely, if the sale price is fixed for some reason (e.g., a listing agreement) and market prices for similar investments rise dramatically during the marketing period, the seller will have lost the opportunity to realize the increased value.

The “quickly” and “certainty” variables work together when determining the value of an investment. Relative to immediately marketable investments, the value of illiquid investments (regardless of the level of value) must be discounted to reflect the uncertainty of the time and price of sale. This uncertainty is reflected in business valuations by what is commonly known as the “discount for lack of marketability” (DLOM).

Logically, the economic costs of time and price uncertainty can be reduced to the price risk faced by an investor during the particular period of time that an illiquid investment is being offered for sale. In the market for publicly traded stocks, the volatility of stock prices represents risk. Investments with no price volatility have no DLOM, because they can be arbitraged to negate the risk of a period of restricted marketing. Conversely, volatile investments that are immediately marketable can be sold at the current price to avoid the risk of future volatility. The illiquidity experienced by the seller of a non-public business interest during the marketing period therefore represents an economic cost reflective of the risk associated with the inability to realize gains and to avoid losses during the period of illiquidity. The longer that time period, the more the value of the business is exposed to adverse events in the marketplace and adverse changes in the operations of the business, and the greater the DLOM that is required to equate the investment to an immediately liquid counterpart.

Conventional business valuation has used the well-publicized results of restricted stock studies, pre-IPO studies, and registered versus unregistered stock studies to effectively guess at appropriate DLOM percentages to use in their valuation reports. Understandably, such subjective means of applying the traditional approaches have been broadly unsatisfactory to the valuation community and the courts.

A variety of data sources or types have been employed by researchers to perform empirical studies to explore the cost of illiquidity. Some of the most widely used data sources are described below.
A. Publicly traded companies are the standard against which all of the studies measure results and from which rates of return are calculated. Interests in publicly traded companies are worth more than interests in identical privately held companies because they can be sold immediately to realize gains and to avoid losses. Interests in privately held companies cannot.
B. Private sales of publicly registered stocks typically involve large blocks of stock that could be sold into the public marketplace, but which would materially adversely affect stock prices if the entire block were to be dumped into the market at once. Avoiding that effect results in an extended period of time to liquidate the investment position in the public market during which time the investor is subject to market risk. Negotiating a private sale of the block can accelerate liquidating the position, but the need to find a buyer with the wherewithal to purchase the block restricts the number of potential buyers and represents a diminution of demand for the stock. Furthermore, although private sales of large blocks of registered stocks can somewhat mitigate the market risk, the risk does not go away. The buyer of the block assumes the risks, in turn, of having to sell into a limited pool of buyers or slowly feeding the block into the public market. These risks require compensation by means of a discount (i.e. DLOM).
C. Private sales of restricted stocks in public companies have the same price risks as private sales of large blocks of registered stocks, but have the additional risk of being locked out of the public market for specific periods of time or being subject to restrictive “dribble out” rules. Accordingly, restricted stocks often can only be sold quickly in private sale transactions, which take longer than it does to sell unrestricted stocks in the public market. Some restricted stocks cannot be sold at all for contractually determined periods of time. Such investments have even greater economic risks than those merely subject to the “dribble out” rules. The result is that a restricted registered stock is worth less than an unrestricted stock in the same company because of the greater market risk associated with the extended marketing period.
D. Private sales of unregistered stocks in public companies typically involve large blocks of stock. They are worth less than equivalent blocks of registered stock (whether restricted or unrestricted) in the same publicly traded company because there is a cost to ultimate registration of the stock that further restricts the potential number of buyers of the block. This results in relatively greater uncertainty, a relatively longer time to market the interest, and a relatively greater exposure to the risks of the marketplace.
E. Pre-IPO private sales of controlling interests should have relatively longer marketing periods than for private sales of unregistered stocks in public companies, because the fact and timing of the IPO event can be uncertain. Furthermore, low pre-IPO stock sales prices may reflect compensation for services rendered. There are no publically known studies that specifically address discounts observed in sales of controlling interests in pre-IPO companies.
F. Private sales of controlling interests in a company that has no expectation of going public should be worth less than an otherwise identical company with an anticipated IPO event. Uncertain or not, an anticipated IPO event should result in a shorter marketing period than not anticipating such an event.
G. Pre-IPO sales of non-controlling interests in a company planning an IPO event should be worth less than the controlling interest in the same company even without the planned IPO. The inability to control whether the planned IPO goes forward should result in greater uncertainty and a longer marketing period to liquidate the investment than would be experienced by the controlling investor. Also, low pre-IPO share prices may reflect compensation for services rendered.
H. Non-controlling interests in private companies require greater discounts than all of the preceding circumstances because the relative risks of lacking control cause the period of time to liquidate the position to be potentially much longer than for the controlling interest in the same company or for otherwise comparable minority positions in firms with a planned IPO event.

Restricted stock studies and pre-initial public offering (“pre-IPO”) studies have been used to quantify DLOM since the early 1970s. Despite making a good case for the need for a DLOM when valuing an investment that is not immediately marketable, the study results are unreliable for calculating the DLOM applicable to a particular valuation engagement.

Unfortunately, the empirical studies of marketability discounts have limited utility to the appraiser opining on the fair market value of a business interest. Several authors have noted that most publicly traded firms do not issue restricted stock. This dearth necessitates samples of limited sizes, in limited industries, with data spread over long periods of time. The result has been substantial standard errors in their estimates.

The restricted stock studies measure the difference in value between a publicly traded stock with and without a time restriction on sale. Left unanswered is whether there is a difference between the restricted stock value of a publicly traded company and the value of that company if it were not publicly traded at all.

The pre-IPO studies reflect substantial standard errors in their estimates for similar reasons, but are also distorted by the facts that the studies necessarily are limited to successful IPOs; there are no post-IPO stock prices for failed IPOs. The discounts observed in the pre-IPO studies may also reflect uncertainty about whether the IPO event will actually occur, when the IPO event will occur, at what price the event will occur, and compensation for services rendered.

It should also be noted that the companies in the restricted stock and pre-IPO studies are, in fact, publicly traded. But essentially none of the privately held companies that are the subject of business valuations have a foreseeable expectation of going public. Accordingly, the circumstances of the privately held companies are highly distinguishable from those of the publicly traded companies that are the subjects of the studies. Thus, the pre-IPO studies are of dubious value for determining the DLOM of privately held companies.

There is at least one known study of the difference in value between private sales of registered stocks and private sales of unregistered stocks in the same publicly traded company. The result is a measure of the value of registration; it is not a measure of liquidity, much less a measure of DLOM. It is not appropriate to estimate DLOM and fair market value (FMV) relying exclusively on lack of registration, which is a factor subsumed in the time it takes to market an interest in a private company. Likewise, brokerage and transactions costs should not be deducted from fair market value appraisals. The result of such deductions would be values that no longer represent the price at which the investments change hands between buyers and sellers—a requirement of fair market value.

Restricted Stock Studies

Restricted stocks are public company stocks subject to limited public trading pursuant to SEC Rule 144. Restricted stock studies attempt to quantify DLOM by comparing the sale price of publicly traded shares to the sale price of otherwise identical marketability-restricted shares of the same company. The average (“mean”) marketability discount and related standard deviation (where available) determined by each of the published restricted stock studies is provided in FIG. 1.

In 1997, the SEC reduced the two-year restriction period of Rule 144 to one year. Subsequently, Columbia Financial Advisors, Inc. completed a study that analyzed restricted stock sales from May 1997 through December 1998. This study found a range of discounts from 0% to 30%, and a mean discount of 13%. The conclusion reached from this study is that shorter restriction periods result in lower discounts. In 2008, the SEC further reduced the Rule 144 restriction period to six months. According to the Internal Revenue Service, as of the present date no restricted stock studies have been published that reflect the six-month holding period requirement. Considering the age of the restricted stock studies, the Rule 144 transitions, and changes in market conditions, concluding that a DLOM derived from the above studies ignores current market data and conditions seems unavoidable.

Appraisers face other serious problems when relying on these studies. Because the sample sizes of the restricted stock studies are small, most involving less than 100 individual data points, the reliability of the summary statistics is subject to considerable data variation. This fact alone calls the reliability of the studies into question. But the studies also report high standard deviations, as shown in the FIG. 1, indicating the probability of a very broad range of underlying data points. Relying solely on the averages of these studies is, therefore, likely to lead the appraiser to an erroneous DLOM conclusion.

A graphical model of a 200,000-trial normal statistical distribution based on the reported means and standard deviations of the 146-observation Moroney study was generated using a predictive modeling, forecasting, simulation, or optimization application, such as Crystal Ball from the Oracle Corporation of Redwood City, Calif. Crystal Ball is a widely accepted modeling software program that uses a Monte Carlo simulation to randomly generate values for uncertain variables based on defined assumptions. The model discloses that the potential range of discounts comprising the 35% mean discount of the Moroney study is from negative 44.5% to positive 113.9%. Applying the same normal distribution analysis to the Maher, Silber, and Management Planning studies discloses that the potential range of discounts comprising the Maher study average of 35.0% is from negative 41.0% to positive 110.6%; the potential range of discounts comprising the Silber study average of 34.0% is from negative 75.8% to positive 138.0%; the potential range of discounts comprising the 49-observation Management Planning study is from negative 32.5% to positive 83.1%; and the potential range of discounts comprising the 20-observation Management Planning study is from negative 29.9% to positive 83.7%.

Common sense tells one that a DLOM cannot be negative. Therefore, normal statistical distribution likely cannot be the appropriate assumption regarding the distribution of the population of restricted stocks. A log-normal distribution may instead be assumed for the population. Using Crystal Ball or similar application with the log-normal assumption and 200,000 trials resulted in a graphical model that discloses that the log-normal range of discounts comprising the Moroney study is from 3.7% to 269.2% with a median discount of 31.1%. Approximately 60% of probable outcomes occur below the study mean.

Applying the same log-normal distribution analysis to the Maher, Silber, and Management Planning studies, we find: the log-normal range of discounts comprising the Maher study is from 4.0% to 276.6% with a median discount of 31.2%; the log-normal range of discounts comprising the Silber study is from 2.0% to 472.8% with a median discount of 27.8%; the log-normal range of discounts comprising the Management Planning study is from 2.7% to 233.1% with a median discount of 25.0%. In each of these studies, approximately 60% or more of probable outcomes occur below the study mean.

Even assuming a log-normal distribution the appraiser is left with two problems. First, what should be done about the fact that some portion of the distribution continues to imply a DLOM greater than 100%? That result should not simply be ignored. Some form of adjustment may be required. Second, with 60% or more of the predicted outcomes occurring below the reported means of the studies, there is no basis for assuming a DLOM based on a study's mean (or an average of studies' means). These issues, the inability of the studies to reflect market dynamics (past or present), the inability to associate the studies with a specific valuation date, and the inability to associate the study results to a valuation subject with any specificity, seriously call into question the reliability of basing DLOM conclusions on restricted stock studies.

### Pre-IPO Studies

Pre-IPO studies analyze otherwise identical stocks of a company by comparing prices before and as-of the IPO date. As with the restricted stock studies, the valuation utility of the pre-IPO studies is seriously flawed. For example, the “before” dates of these studies use different measurement points ranging from several days to several months prior to the IPO. Determining a “before” date that avoids market bias and changes in the IPO company can be a difficult task. If the “before” date is too close to the IPO date, the price might be affected by the prospects of the company's IPO. If the “before” date is too far from the IPO date, overall market conditions or company specific conditions might have changed significantly. Such circumstances undermine the use of pre-IPO studies to estimate a specific DLOM.

The Internal Revenue Service document, Discount for Lack of Marketability Job Aid for IRS Valuation Professionals, published Sep. 25, 2009, the disclosure of which is hereby incorporated herein by reference, discusses three pre-IPO studies: the Willamette Management Associates studies; the Robert W. Baird & Company studies; and the Valuation Advisors' Lack of Marketability Discount Study. Each of these studies suffers from deficiencies that undermine their usefulness for estimating the DLOM applicable to a specific business as of a specific date. First, the Willamette and Baird & Company studies were of limited size and are not ongoing. The Willamette studies covered 1,007 transactions over the years 1975 through 1997 (an average of 44 transactions per year), while the Baird & Company studies covered 346 transactions over various time periods from 1981 through 2000 (an average of 17 transactions per year). While the Valuation Advisors studies are ongoing and larger than the others, covering at least 9,075 transactions over the years 1985 to present, it represents an average of just 336 pre-IPO transactions per year. Although larger than the restricted stock studies discussed in the previous section, the sample sizes of these pre-IPO studies remain small on an annual basis and subject to considerable data variation. This fact alone calls the reliability of the pre-IPO studies into question.

Second, the Willamette and Baird & Company studies report a broad range of averages, and very high standard deviations relative to their means (reflecting the broad range of underlying data points). The “original” Willamette studies report standard mean discounts that average 39.1% and standard deviations that average 43.2%. The “subsequent” Willamette studies report standard mean discounts that average 46.7% and standard deviations that average 44.8%. And the Baird & Company studies report standard mean discounts that average 46% and standard deviations that average 45%.

Using Crystal Ball or a similar application to model a 200,000-trial normal statistical distribution based on the reported means and standard deviations of the “original” Willamette studies discloses that a potential range of discounts comprising the 39.1% mean discount of this study ranges from negative 167.6% to positive 235.8%.

Applying the same normal distribution analysis to the “subsequent” Willamette studies and the Baird & Company studies discloses that the potential range of discounts comprising the “subsequent” Willamette studies is from negative 151.2% to positive 239.9%. And the normal distribution of a 206-observation subset of the aforementioned Baird & Company studies with a reported mean discount of 44% and standard deviation of 21% discloses that the potential range of discounts ranges from negative 59.8% to positive 150.6%.

As with the restricted stock studies, common sense tells one that a DLOM cannot be negative. Therefore, normal statistical distribution likely cannot be the appropriate assumption regarding the distribution of discounts within the populations, and a log-normal distribution may be assumed instead. Using Crystal Ball or a similar application and the log-normal assumption and 200,000 trials results in a graphical model that discloses that the log-normal range of discounts comprising the “original” Willamette study ranges from 0.5% to 1,151.2% with a median discount of 26.3%. Almost 70% of probable outcomes occur below the 39.1% mean discount of the study.

On a log-normal basis, the potential range of discounts comprising the “subsequent” Willamette studies is from 1.3% to 1,192.9% with a median discount of 33.8%. Over 60% of probable outcomes occur below the mean discount of the study. And on a log-normal basis the potential range of discounts comprising the Baird & Company studies is from 5.7% to 327.3% with a median discount of 42.7%. Approximately 60% of probable outcomes occur below the mean discount of the study.

These statistical problems of the pre-IPO studies and the inability to (a) align with past and present market dynamics; (b) a specific valuation date; and (c) a specific valuation subject, seriously call into question the reliability of basing DLOM conclusions on pre-IPO studies.

Third, the volume of IPO transactions underlying the pre-IPO studies is shallow and erratic. In the last approximately five years the peak volume of offerings was 26 (November 2010) and in January 2009 there were no IPOs at all. From September 2008 through March 2009 the average number of IPOs priced was less than 1.3 per month. It is difficult to understand a rationale for estimating DLOM for a specific privately held company at a specific point in time based on such limited data.

Fourth, the Tax Court has found DLOM based on the pre-IPO approach to be unreliable. In McCord v. Commissioner, 120 T.C. 358 (2003), the court concluded that the pre-IPO studies may reflect more than just the availability of a ready market. Other criticisms were that the Baird & Company study is biased because it does not sufficiently take into account the highest sales prices in pre-IPO transactions and the Willamette studies provide insufficient disclosure to be useful.

Problems with Existing Analytical Methods to Measure DLOM

It has been suggested that the Black-Sholes Option Pricing Model (“BSOPM”) represents a solution to the DLOM conundrum. It does not. BSCPM is not equivalent to DLOM on a theoretical basis. BSOPM is designed to measure European put and call options. European put options represent the right, but not the obligation, to sell stock for a specified price at a specified point in time. European call options represent the right, but not the obligation, to buy stock for a specified price at a specified point in time. DLOM is not the equivalent of either. Instead, DLOM represents the risk of being unable to sell at at the marketable equivalent price for a specified period of time.

“At the money” put options have also been suggested as a means of estimating DLOM. Such options represent the right, but not the obligation, to sell stock at the current price at a specified future point in time. Such options do not measure the risk of illiquidity, because the investor is not denied the opportunity to sell for a price that is higher than the put price.

The Longstaff Approach for Computing DLOM

The critical value difference between publicly traded and privately held companies is that publicly traded investments offer liquidity. All other components of business value are shared: earnings and cash flow, growth, industry risk, size risk, and market risk. However, it is not the value of liquidity per se that DLOM seeks to capture. Instead, it is the risk associated with illiquidity.

Liquidity is the ability to sell quickly when the investor decides to sell. Liquidity allows investors to sell investments quickly to lock in gains or to avoid losses. DLOM, being the result of illiquidity, represents the economic risk associated with failing to realize gains or failing to avoid losses on an investment during the period the investor is trying to sell it. This is not necessarily a zero sum game. The value of liquidity (measured, for example, as the spread between registered and unregistered stocks of the same publicly traded company) does not translate into the economic risks faced by investors in private companies. This is because such measures of liquidity do not account for the even longer marketing periods likely to be incurred by investors in private companies compared to investors in unregistered stocks of otherwise publicly traded companies.

Logically, DLOM can be reduced to price risk faced by an investor during a particular marketing period. In the market for publicly traded stocks, risk reflects the volatility of stock prices. Conversely, investments with no price volatility or that are immediately marketable have no DLOM. Investments with no price volatility can be arbitraged to negate the period of restricted marketing, while volatile investments that are immediately marketable can be sold at the current price to avoid future volatility.

In 1995, UCLA professor Francis A. Longstaff published an article in The Journal of Finance, Volume I, No. 5, December 1995, the disclosure of which is hereby incorporated herein by reference, that presented a simple analytical upper bound on the value of marketability using “look back” option pricing theory. Longstaff's analysis demonstrated that discounts for lack of marketability (“DLOM”) can be large even when the illiquidity period is very short. Importantly, the results of Longstaff's formula provide insight into the relationship of DLOM and the length of time of a marketability restriction. Longstaff described the “intuition” behind the results of his formula as follows—
[Consider] a hypothetical investor with perfect market timing ability who is restricted from selling a security for T periods. If the marketability restriction were to be relaxed, the investor could then sell when the price of the security reached its maximum. Thus, if the marketability restriction were relaxed, the incremental cash flow to the investor would essentially be the same as if he swapped the time-T value of the security for the maximum price attained by the security. The present value of this lookback or liquidity swap represents the value of marketability for this hypothetical investor, and provides an upper bound for any actual investor with imperfect market timing ability.

FIG. 2 is a graphical presentation of Longstaff's description, in which an investor receives a share of stock worth $100 at time zero, but which he cannot sell for T=2 years when the stock is worth $154 (present value at T=0 discounted at a risk free rate of 5%=$139). If at its peak value the stock were worth $194 (present value at T=0 discounted at a risk free rate of 5%=$180), then the present value cost of the restriction to the investor at T=0 would be $41, or 41% of his $100 investment.

The mathematical formula of this scenario is—

$$Discount = V ( 2 + \frac{{σ}^{2} T}{2} ) N ( \frac{\sqrt{{σ}^{2} T}}{2} ) + V \sqrt{\frac{{σ}^{2} T}{2 π}} exp ( - \frac{{σ}^{2} T}{8} ) - V$$

where:
V=current value of the investment
σ=volatility
T=marketability restriction period
N=standard normal cumulative distribution function
exp(x)=Euler's constant (e=2.71828182845904) raised to the x power

Criticisms of what is now known as the Longstaff methodology have focused on three perceived defects: (1) no investor has perfect knowledge; (2) a DLOM based on an upper bound is excessive; and (3) the look back option formula “breaks down” with long marketing periods and high price volatilities. Each of these criticisms is wrong for the reasons described below.

### The “Perfect Knowledge” Criticism

The “perfect knowledge” criticism is based on a defective definition of market timing in a valuation context. The context considered by Dr. Longstaff was one of an investor looking back in time to observe precisely when an investment could have been sold at its maximum value. Dr. Longstaff implicitly assumed that the maximum price could have been reached at any point during the look back period. But in a valuation context this seemingly reasonable assumption is not appropriate. Instead, the maximum price occurs on the valuation date and is the marketable value of the valuation subject. Appraisers determine this value in the ordinary course of their work.

Standing on the vantage point of the valuation date and applying look back option pricing to calculate DLOM in a business valuation inherently assumes that the maximum price that the investor could have realized for the investment is the marketable equivalent price as of that date. The value of the investment beyond the valuation date is necessarily less. This is because the time value of money diminishes the present value of the marketable equivalent price over the course of the marketing period; the foreseeable favorable events affecting the valuation subject have been factored into the analysis; and investors are averse to the risks of price volatility. Thus, if the appraiser properly determined the marketable equivalent price as of the valuation date, then that price is the “maximum value” postulated by Dr. Longstaff.

### The “Upper Bound” Criticism

Dr. Longstaff described the framework in which an upper bound on the value of marketability is derived as one lacking the assumptions about informational asymmetries, investor preferences, and other variables that would be required for a general equilibrium model. Dr. Longstaff recognized that the cost of illiquidity is less for an investor with imperfect market timing than it is for an investor possessing perfect market timing. These considerations are the basis of the “upper bound” limitation of the Longstaff methodology.

It is understood that the cost of illiquidity should be less for the average investor with imperfect market timing than it is for an investor possessing perfect market timing. But the “upper bound” criticism resulting from this situation is nonetheless defective in the valuation context because it can be circumvented by using volatility estimates that represent average, not peak, volatility expectations. For example, the appraiser's volatility estimate may be based on some average or regression of historical price volatility derived from an index or from one or more publicly traded guideline companies. In one embodiment, one or more guideline companies that have characteristics in common with the asset to be valued are identified. An annualized average stock price volatility for each of the guideline companies may be calculated, for example, based on a historical period of time equal to the period of time that it is believed it will take to market the asset being valued. Other means of estimation may be used. The calculated volatilities can be averaged using a simple, weighted, harmonic, or other averaging methodology.

Using average volatility estimates in the look back option formula results in a value that is less than the “upper bound” value. Indeed, a value calculated using average expected volatility suggests a result that is achievable by the average imperfect investor. The resulting value determined in this manner appropriately falls short of a value based on perfect market timing while providing for the informational asymmetry lacking in Dr. Longstaff's more simplified framework.

Accordingly, the “upper bound” criticism has no significance in a proper application of the Longstaff methodology.

### The “Formula Breaks Down” Criticism

The IRS publication “Discount for Lack of Marketability—Job Aid for IRS Valuation Professionals” makes the statement that volatilities in excess of 30% are not “realistic” for estimating DLOM using look back option pricing models. In support of this contention, the publication provides a table reporting marketability discounts in excess of 100% resulting from using combinations of variables of at least 50% volatility with a 5-year marketing period and 70% volatility with a 2-year marketing period. When that occurs, the Longstaff DLOM should simply be capped at 100%. After all, the criticism is not that the formula incorrectly calculates DLOMs below the 100% limit; merely that DLOM cannot exceed 100%.

For example, Longstaff DLOMs for an exemplary asset calculated based on a 20% price volatility assumption and a broad range of marketing periods indicate that it takes about 6,970 days—over 19 years—for the discount to reach 100%. Considering that the typical business sells in about 200 days, a criticism based on a 19-year marketing period is clearly unreasonable. As the expected price volatility increases, a shorter time is typically required to reach 100% and vice-versa. Considering that the average period of time in which a private business sells is about 200 days, it is unlikely that typical appraisers will define look back option variables that result in Longstaff DLOMs that exceed 100%.

Some appraisers may nonetheless struggle with the idea of using a formula to calculate DLOM that “breaks down” under certain assumptions. The dilemma is avoided by applying the formula Adjusted DLOM=Average DLOM/(1+Average DLOM). This adjustment assures that even with the highest volatilities and longest marketing periods DLOM never exceeds 100%. For example, the IRS publication reports a discount percentage of 106.7% based on an estimated 70% price volatility over an estimated 2-year post valuation date marketing period. The DLOM percentage resulting from the same parameters and using the above technique is 51.6%. This modification of the Longstaff method makes it mathematically impossible for the resulting percentage to equal or exceed 100% of the marketable value of the valuation subject. But adjusted DLOM increasingly understates Longstaff DLOM as the marketing period assumption lengthens and as the price volatility assumption elevates.

Because the variables entering into the generally accepted look back option formula can be objectively determined and verified, the formula can be tailored to specific assets at specific points in time. Thus, carefully crafted applications of the Longstaff approach provide appraisers with a powerful tool for estimating (or challenging) discounts for lack of marketability.

There is a need in the art for a reliable method for calculating a DLOM when valuing an investment that is not immediately marketable. Such a method that takes into account a variety of variables and that is tailored to the characteristics of a particular asset to be valued as of a particular day would also be advantageous. There is also a need for computer-based applications that aid users in generating such a DLOM quickly and easily based on a selected set of variables.

### SUMMARY

Embodiments of the invention are defined by the claims below, not this summary. A high-level overview of various aspects of the invention are provided here for that reason, to provide an overview of the disclosure, and to introduce a selection of concepts that are further described in the Detailed-Description section below. This summary is not intended to identify key features or essential features of the claimed subject matter, nor is it intended to be used as an aid in isolation to determine the scope of the claimed subject matter. In brief, this disclosure describes, among other things, methods, computer-readable media, and systems that provide ways to generate a discount for lack of marketability (DLOM) for an asset, such as a private business, that is useable in valuation of the asset.

In one embodiment, a computer-executable application is provided that prompts a user for selection of a database that includes data associated with previously completed transactions for sales of assets. The user is also prompted for selection of one or more parameters associated with the asset and that are useable to identify subsets of data within the database and for an estimated volatility of the asset.

A mean and standard deviation of the transaction periods associated with the transactions in the database is determined for the total population and for each subset defined by the selected parameters. Based on these calculations, an adjusted mean and standard deviation may be determined. A statistical modeling engine is employed to transform the unadjusted or adjusted mean and standard deviation into a probability distribution indicating the probability that the asset will sell at a given time.

A formula, such as the Longstaff Model, is employed to determine a period-specific DLOM for a plurality of time periods occurring within the time scale of the probability distribution. The period-specific DLOMs are weighted using the probability associated therewith and defined by the probability distribution and are combined to form a probability weighted DLOM for the asset. The probability weighted DLOM as well as a visualization of the probability distribution, and one or more additional data elements are presented to the user via the user interface.

### DESCRIPTION OF THE DRAWINGS

Illustrative embodiments of the invention are described in detail below with reference to the attached drawing figures, and wherein:

FIG. 1 depicts a compilation of data reported for selected published restricted stock studies;

FIG. 2 is a graphical presentation depicting a value of a stock over a period of time;

FIG. 3 is a block diagram depicting an exemplary computing device suitable for use in embodiments of the invention;

FIG. 4 is a block diagram depicting an exemplary networked operating environment suitable for use in embodiments of the invention;

FIG. 5 is a flow diagram depicting a method for providing a probability adjusted discount for lack of marketability for an asset depicted in accordance with an embodiment of the invention;

FIG. 6 is a flow diagram depicting additional steps that may be employed in the method depicted in FIG. 5 in accordance with an embodiment of the invention;

FIG. 7 is a graphical representation of a probability distribution produced by a statistical modeling engine in accordance with an embodiment of the invention;

FIG. 8 is a flow diagram depicting additional steps useable with the method depicted in FIG. 5 in accordance with an embodiment of the invention;

FIG. 9 is a flow diagram depicting another method for providing a probability adjusted discount for lack of marketability for an asset depicted in accordance with an embodiment of the invention;

FIG. 10 is an illustrative view of a user interface depicted in accordance with an embodiment of the invention;

FIG. 11 is a block diagram of a system for providing a probability adjusted discount for lack of marketability for an asset depicted in accordance with an embodiment of the invention;

FIG. 12 is a graphical representation of a probability distribution produced by a statistical modeling engine for a private business to be valued in accordance with an embodiment of the invention; and

FIG. 13 is a table of a selection of data elements represented by the graphical representation of FIG. 12.

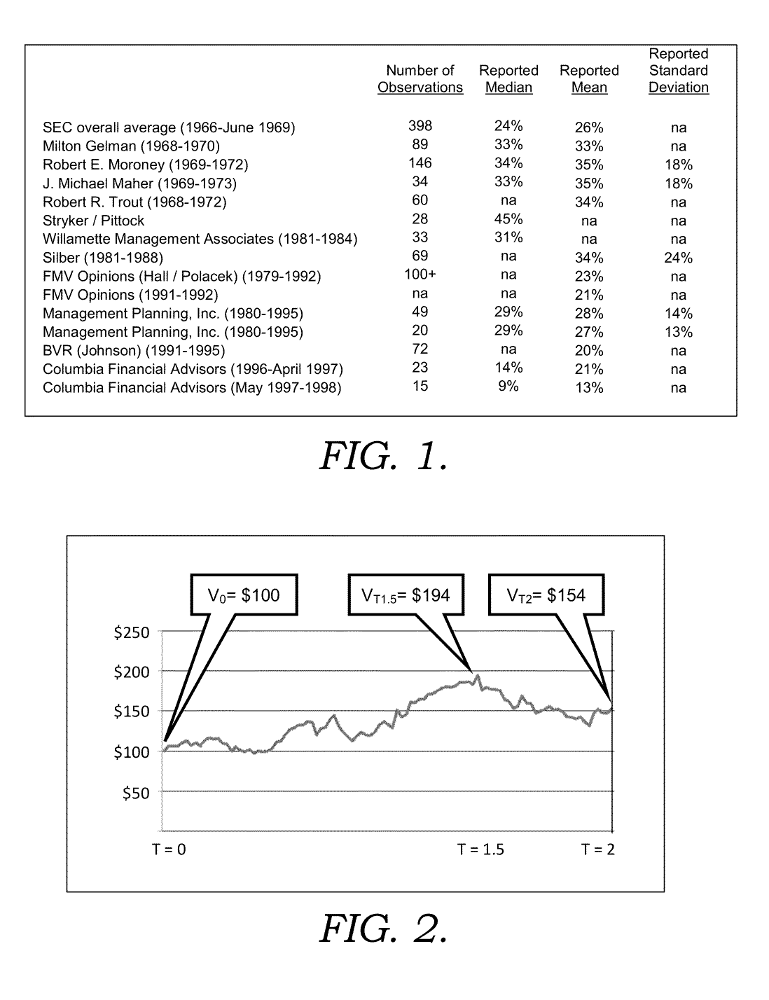

### DETAILED DESCRIPTION

The subject matter of select embodiments of the invention is described with specificity herein to meet statutory requirements. But the description itself is not intended to necessarily limit the scope of claims. Rather, the claimed subject matter might be embodied in other ways to include different components, steps, or combinations thereof similar to the ones described in this document, in conjunction with other present or future technologies. Terms should not be interpreted as implying any particular order among or between various steps herein disclosed unless and except when the order of individual steps is explicitly described.

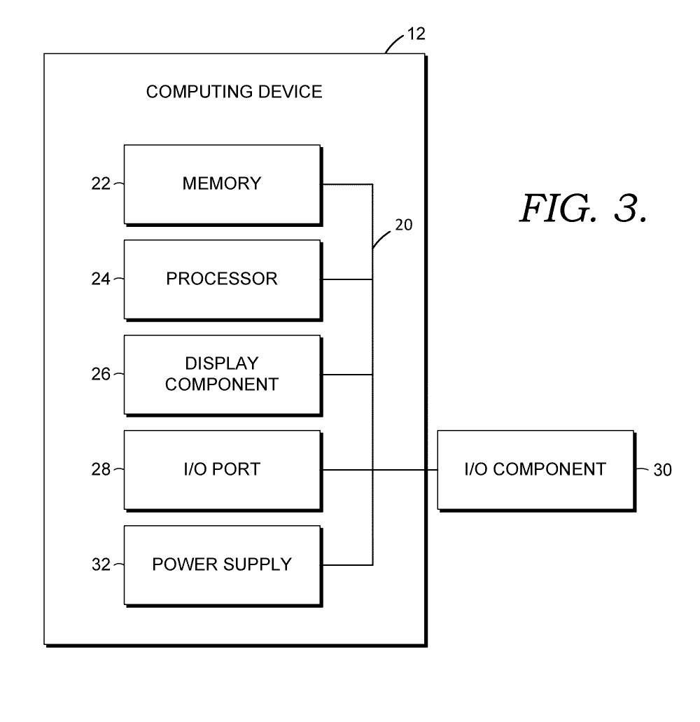

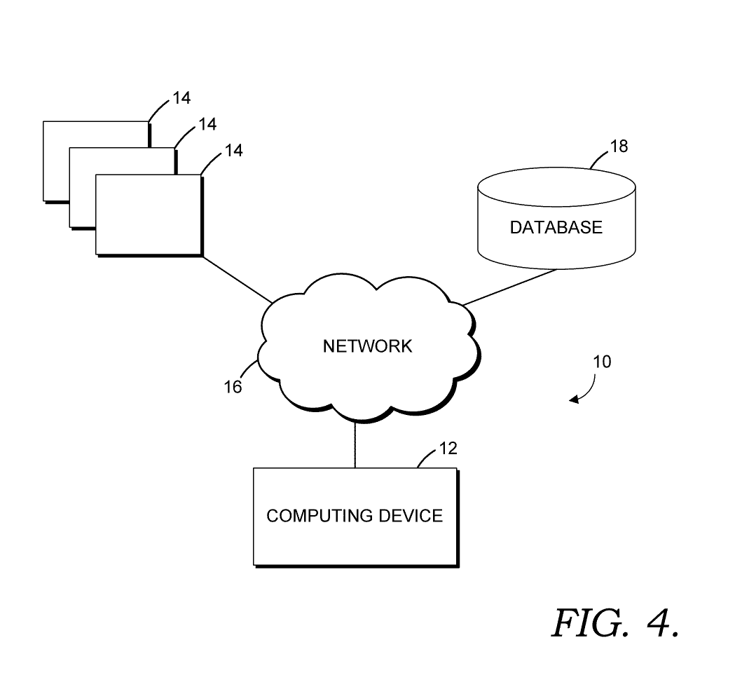

With initial reference to FIG. 3, an exemplary computing device 12 for implementing embodiments of the invention is shown in accordance with an embodiment of the invention. The computing device 12 is but one example of a suitable computing device and is not intended to suggest any limitation as to the scope of use or functionality of embodiments of the invention. The computing device 12 should not be interpreted as having any dependency or requirement relating to any one or combination of components illustrated. FIG. 4 depicts an exemplary operating environment 10 in which the computing device 12 may be disposed in a networked configuration. Although many components of the operating environment 10 and the computing device 12 are not shown or described herein, it is appreciated that such components and their interconnection are well known. Accordingly, additional details concerning the construction of the operating environment 10 and the computing device 12 are not further disclosed herein.

Embodiments of the invention may be practiced in a variety of system configurations, including hand-held devices, consumer electronics, general-purpose computers, specialty computing devices, and the like. The computing device 12 is inclusive of devices referred to as workstations, servers, desktops, laptops, hand-held device, and the like as all are contemplated within the scope of FIGS. 3 and 4 and in references to the computing device 12.

Embodiments of the invention may be practiced by a stand-alone computing device as depicted in FIG. 3 and/or in distributed computing environments where one or more tasks are performed by remote-processing devices 14 that are linked through a communications network 16 (FIG. 4). The remote-processing devices 14 comprise a computing device that may be configured like the computing device 12. An exemplary computer network 16 may include, without limitation, local area networks (LANs) and/or wide area networks (WANs). Such networking environments are commonplace in offices, enterprise-wide computer networks, intranets and the Internet. When utilized in a WAN networking environment, the computing device 12 may include a modem or other means for establishing communications over the WAN, such as the Internet. In a networked environment, program modules or portions thereof may be stored in association with the computing device 12, a database 18, or one or more remote computers 14. For example, and not limitation, various application programs may reside on memory associated with any one or more of the remote computers 14. It will be appreciated that the network connections shown are exemplary and other means of establishing a communications link between the computers (e.g., the computing device 12 and the remote computers 14) may be utilized.

Embodiments of the invention may be described in the general context of computer code or machine-useable instructions, including computer-executable instructions, such as program modules being executed by a computer or other machine, like a smartphone, tablet computer, or other device. Generally, program modules including routines, programs, objects, components, data structures, or the like, refers to code that performs particular tasks or implements particular abstract data types.

With continued reference to FIG. 3, the computing device 12 includes one or more system busses 20, such as an address bus, a peripheral bus, a local bus, a data bus, or the like, that directly or indirectly couple components of the computing device 12. The bus 20 may comprise, for example, an Industry Standard Architecture (ISA) bus, Micro Channel Architecture (MCA) bus, Enhanced ISA (EISA) bus, Video Electronic Standards Association (VESA) local bus, a Peripheral Component Interconnect (PCI) bus, among other bus architectures available in the art.

The bus 20 couples components like internal memories 22, processors 24, display components 26, input/output (I/O) ports 28 and I/O components 30 coupled thereto, and a power supply 32. Such components may be provided singly, in multiples, or not at all as desired in a particular configuration of the computing device 12. As indicated previously, additional components might also be included in the computing device 12 but are not shown or described herein so as not to obscure embodiments of the invention. Such components are understood as being within the scope of embodiments of the invention described herein.

The memory 22 of the computing device 12 typically comprises a variety of non-transitory computer-readable media in the form of volatile and/or nonvolatile memory that may be removable, non-removable, or a combination thereof. Computer-readable media include computer-storage media and computer-storage devices and are mutually exclusive of communication media, e.g. carrier waves, signals, and the like. By way of example, and not limitation, computer-readable media may comprise Random Access Memory (RAM); Read-Only Memory (ROM); Electronically Erasable Programmable Read-Only Memory (EEPROM); flash memory or other memory technologies; compact disc read-only memory (CDROM), digital versatile disks (DVD) or other optical or holographic media; magnetic cassettes, magnetic tape, magnetic disk storage or other magnetic storage devices, or any other medium that can be used to encode desired information and be accessed by the computing device 12.

The processor 24 reads data from various entities such as the memory 22 or the I/O components 30 and carries out instructions embodied thereon or provided thereby.

The display component 26 presents data indications to a user or other device. Exemplary presentation components include a display device, a monitor, a speaker, a printing component, a vibrating component, or other component that produces an output that is recognizable by a user.

The I/O ports 28 allow the computing device 12 to be logically coupled to other devices including the I/O components 30, some of which may be built in. Illustrative components include a microphone, joystick, game pad, satellite dish, scanner, printer, or wireless device, among others.

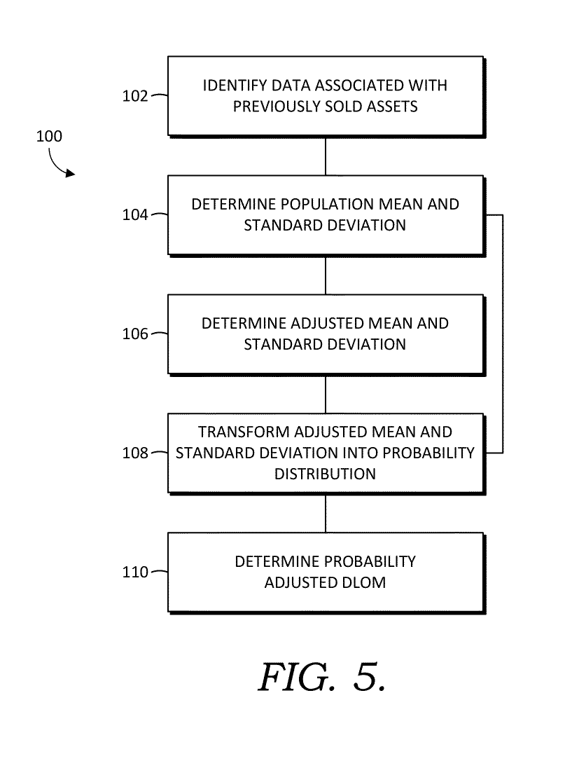

With reference now to FIG. 5, a method 100 for providing a probability adjusted discount for lack of marketability for an asset is described in accordance with an embodiment of the invention. As described herein, the asset being valued comprises a privately held business. However, such is not intended to so limit embodiments of the invention which can be applied to any of a variety of assets for which historical transactional data is available, such as, for example and not limitation, intangible assets, real estate, publicly traded businesses, or restricted stock shares, among many possible applications.

At step 102, data associated with a plurality of transactions for the sale of a population of previously sold assets is identified. The transactions comprise previously closed sales transactions for which at least a listing date and a closing date are available; an indication of a transaction period, e.g. a time between the listing date and the closing date, might also be provided instead of or in addition to the actual listing and closing dates. The listing dates preferably include a month and year of listing of the asset for sale. The data may include a listing price for the asset and an industry classification for the asset, such as a codification of the asset under the Standard Industrial Classification (SIC) system, International SIC (ISIC) system, or North American Industry Classification System (NAICS), or Global Industrial Classification Standard (GICS), among others. Data reflecting additional parameters, like a geographic location of the asset, a rating of the physical or financial condition of the asset, or an indication of the state or nation governing the asset, among other parameters might also be provided.

The transaction data is identified in and/or obtained from a database, such as the database 18, or other storage location. The transaction data may be provided by a third party, such as a party that is in the business of collecting, managing such transactional data. Exemplary transaction data sources include PRATT'S STATS, a database of mergers and acquisitions transactions data provided by Business Valuation Resources of Portland, Oreg.; BIZCOMPS, a database of small business transactions sales data provided by Bizcomps of Las Vegas, Nev.; IBA Market Data, a database of sales transaction data for small to medium businesses provided by The Institute of Business Appraisers of Salt Lake City, Utah; and DoneDeals, a database of mid-market business sales transactions provided by ValuSource of Colorado Springs, Colo. The database 18 can be remotely located and accessed via a network, such as the network 16, or can be housed locally and accessible directly by a user's computing device, e.g. the computing device 12.

A population mean and standard deviation of the transaction periods are determined from the group of all of the transactions identified in the database at step 104. The population mean and standard deviation may then be adjusted to provide an adjusted mean and an adjusted standard deviation of the transaction periods for the transactions described in the transaction data as indicated at step 106. To determine the adjusted mean and standard deviation, the transaction data may be analyzed to identify trends or characteristics in the data for sold assets that have similarities with the asset to be valued. The mean and standard deviation of the population can thus be adjusted to account for those trends or other characteristics. In one embodiment, the mean and standard deviation of the population of sale transactions can be used in furtherance of the invention without adjustment.

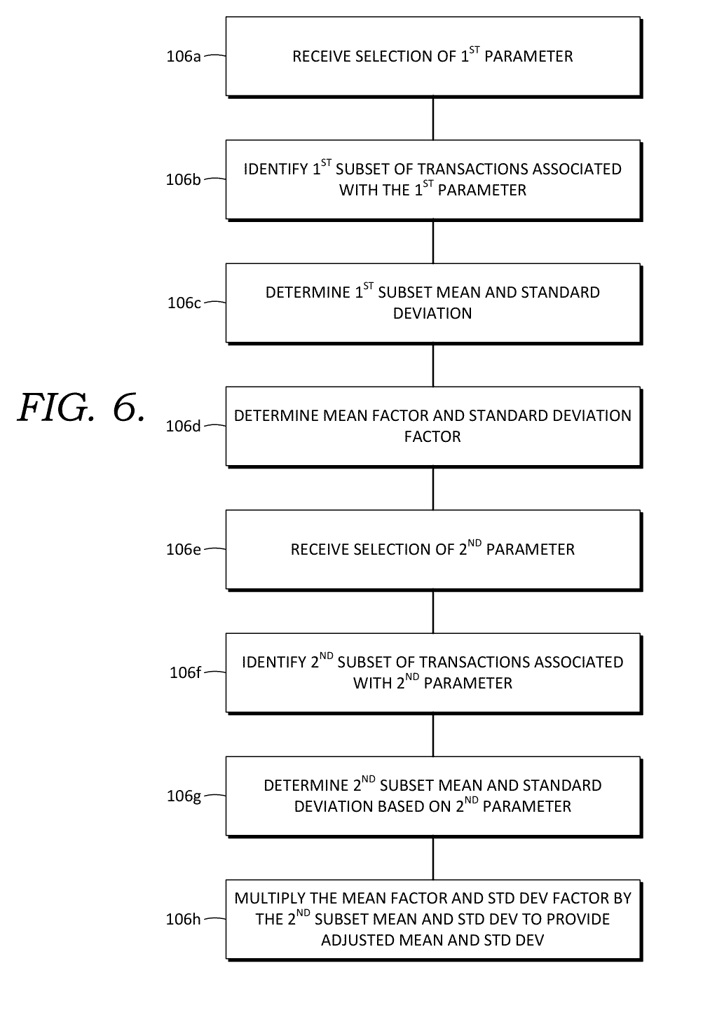

For example, with additional reference to FIG. 6, additional parameters or characteristics of the asset to be valued can be employed to aid analysis of the transaction data and/or to identify subsets of the transaction data for use in adjusting the population mean and standard deviation in accordance with an embodiment of the invention. A selection of a first parameter for the asset is received at step 106a. The first parameter includes a characteristics of the asset to be sold/valued, like, for example, an SIC codification of the asset, a listing price of the asset, a month in which the asset is listed for sale, or a year in which the asset is listed for sale, among a variety of other characteristics for which data is included in the transactional data.

A subset (first subset) of the transactions represented in the transaction data that includes the first parameter, e.g. transactions for sold assets having matching SIC codes, is identified as indicated at step 106b. The mean and standard deviation of the transaction periods for the transactions comprising the first subset is determined as indicated at step 106c. The mean and standard deviation of the first subset may be employed in furtherance of the invention without additional adjustment. Or the mean and standard deviation of the first subset may be utilized to generate a mean factor and a standard deviation factor as indicated at step 106d. The mean factor is equal to the first subset mean divided by the population mean and the standard deviation factor equals the first subset standard deviation divided by the population standard deviation.

A selection of a second parameter, such as a listing price, month of listing, or year of listing, is received at step 106e. A second subset of the transaction data including transactions for sold assets with the second parameter is identified at step 106f and the mean and standard deviation for the transaction periods of the transactions comprising the second subset is determined as indicated at step 106g. The second subset mean and standard deviations are next multiplied by the mean factor and standard deviation factor, respectively, to generate the adjusted mean and the adjusted standard deviation as indicated at step 106h. Any number of additional parameters may also be employed in a similar manner, e.g. by determining a mean and standard deviation of a subset associated with the selected additional parameter, dividing by the population mean and standard deviation, respectively, to generate factors that are then multiplied by the previously calculated adjusted mean and standard deviation as described above.

Returning to FIG. 5, the adjusted mean and standard deviation of the transaction periods for the sold assets are provided to a statistical modeling engine or application. The statistical modeling engine is any one or more modeling engines that are useable to generate a statistical probability distribution indicating the probability that the asset to be valued will sell in a given period of time based on the adjusted mean and adjusted standard deviation provided thereto. For example, the statistical modeling engine may comprise one or more components of the Crystal Ball suite of modeling applications from the Oracle Corporation and may employ any available simulation or forecasting methodologies, such as Monte Carlo simulations and time-series forecasting. The statistical modeling engine transforms the adjusted mean and standard deviation into a probability distribution depicting the probability that the asset to be valued will sell with respect to a length of the transaction period as indicated at step 108.

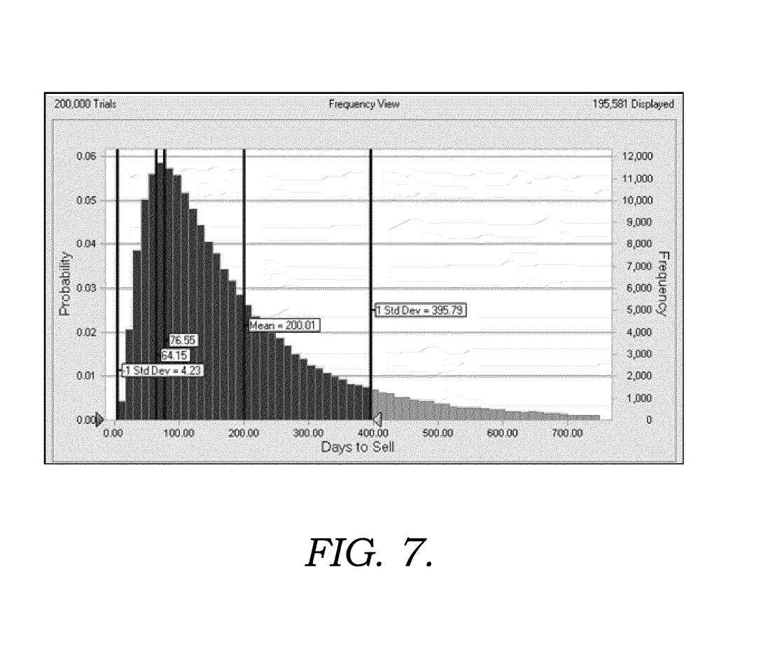

The probability distribution is preferably provided on a natural logarithmic scale (e.g. the logarithm with the base e, where e is approximately equal to 2.71828182845904 or Euler's number) but can employ a base ten logarithmic scale, or other logarithmic or non-logarithmic scale as desired. A graph of an exemplary probability distribution based on a natural logarithmic scale is depicted in FIG. 7.

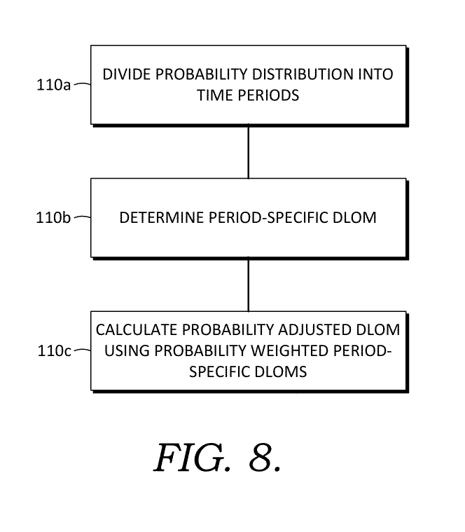

As indicated at FIG. 8, step 110a, the probability distribution is employed to determine a probability weighted DLOM for the asset to be valued. A formula, based on the Longstaff model, such as that depicted above, or a variation thereof is preferably employed to calculate the DLOM for the asset to be valued. Other available models and/or formulas, like other look-back models or various option pricing models might be employed to determine a DLOM for the asset. The calculated DLOM is adjusted based on the probability that the asset will sell in a given transaction period as depicted by the probability distribution.

With additional reference to FIGS. 7-8, the calculated DLOM may be adjusted by first dividing the total transaction period depicted by the probability distribution into a plurality of time segments. Such time segments may consist of periods of equal probability of occurrence among the sale transactions, or otherwise. An upper bound may be placed on the range of distributed transaction periods, e.g. an upper bound might be applied at a transaction period value at or below which the asset is 95% likely to sell, or within a transaction period that is one standard deviation above the mean of the probability distribution, or some other determined limitation.

The total transaction period is divided into any number of time segments that may be equal in length or may vary in length. In one embodiment, the total transaction period is divided based on the cumulative probability associated with the time segments, e.g. a first time segment is defined between time zero and up to a time T₁ when the cumulative probability represented by the probability distribution is equal to 1% and a second time period is defined between time T₁ and a time T₂ at which the cumulative probability is equal to 2%.

A representative time value is selected for each time segment, e.g. the midpoint, initial point, or end point of each time segment is identified. Alternatively, a plurality of representative time values might be selected without reference to particular time segments of the total transaction period. A probability associated with each of the representative time values is identified from the probability distribution. The probabilities may be adjusted based on the upper bound to recalibrate the total of the probabilities to 100%, e.g. if the upper bound is placed at the transaction period within which the asset is 95% likely to sell, then the probabilities associated with each of the segments can be multiplied by approximately 1.053 such that the sum of the probabilities is equal to 100.

The representative time value for each of the segments is input into the chosen DLOM formula along with any other needed inputs, e.g. the estimated price volatility of the asset, to calculate a period-specific DLOM for each of the time segments as indicated at step 110b. It will be obvious to one versed in the art that more than one estimated price volatility may constitute an input, e.g. a separate price volatility could be estimated for each determined time period. Each of the period-specific DLOMs is next weighted based on the probabilities depicted by the probability distribution (or as adjusted to accommodate for an upper bound) by multiplying the period-specific DLOMs by the probability associated with the respective period. The probability weighted DLOM for the asset is calculated by summing the probability weighted period-specific DLOMs as indicated at step 108c. It is understood that one of skill in the art may identify alternative ways or variations of the steps described above that are useable to calculate the probability weighted DLOM; those alternatives and/or variations are within the scope of embodiments of the invention described herein.

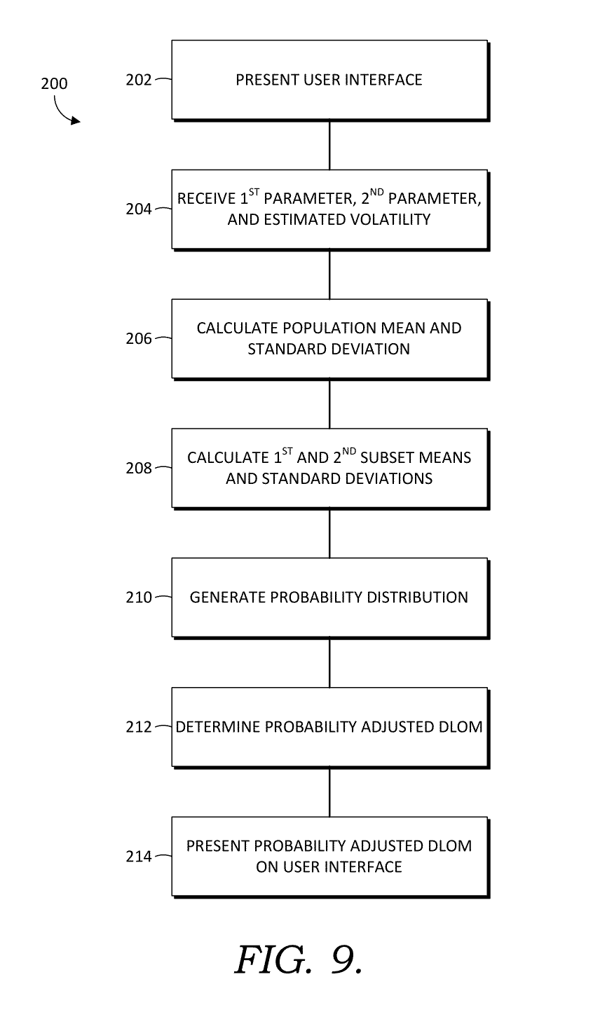

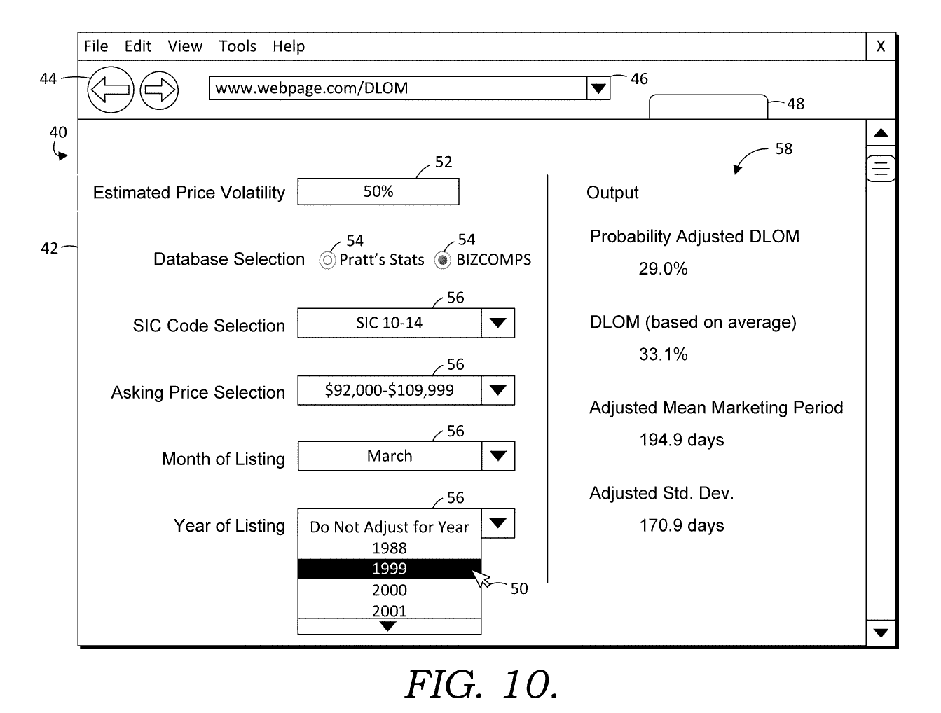

Reference now to FIGS. 9-10, a method 200 for providing a probability adjusted discount for lack of marketability for an asset is described in accordance with an embodiment of the invention. At step 202, a user interface is provided, such as for example the user interface 40 depicted in FIG. 10. The user interface 40 is provided on one or more display devices 26 associated with the computing device 12, as depicted in FIG. 3. The user interface 40 may be provided via the Internet or other network 16 or is generated by an application that is resident on the computing device 12. The user interface 40 is presented in a window 42 which may include one or more control features 44, input fields 46, tabs 48, a pointer 50, or similar features known in the art.

The user interface 40 also includes a plurality of fields 52, 54, 56 in which data associated with the asset to be valued can be input. The fields 52, 54, 56 can be configured in any available manner to enable direct entry of data or selection from one or more available options. For example, the input field 52 allows a user to directly enter an estimated price volatility for the asset by typing a number into the field 52, the fields 54 comprise selectable radio buttons that are selectable by the user to indicate a desired database from which to obtain transaction data, and the fields 56 comprise drop-down menus that allow the user to select parameters associated with the asset. The user interface 40 includes an output portion 58 that is presented alongside the input fields 52, 54, 56 or that can be presented on a separate page, or otherwise, as known in the art. The output portion 58 provides data elements calculated based on the inputs provided to the user interface 40, such as the probability weighted DLOM for the asset, one or more DLOMs calculated based on other available DLOM formulae, and an adjusted mean and standard deviation, among a variety of other outputs available in the art. In one embodiment, the output portion 58 provides a visualization or graph, like, for example, the graph depicted in FIG. 7, depicting the probability distribution, time segments, and/or other available data thereon.

Returning to FIG. 9, one or more parameters and an estimated price volatility for the asset are received from the user via the user interface 40. As discussed previously, the parameters might include one or more of an SIC code, listing price, listing month, or listing year, among a variety of others. A selection of a desired database from which to identify or gather transaction data for previously sold assets may also be received. A population mean and standard deviation for transaction data in the selected database is calculated at step 206. Subset means and standard deviations are calculated for each of the selected parameters based on subsets of the transaction data identified using the selected parameter values at step 208. In one embodiment, the calculations using the transaction data may be precompiled and/or cached in advance and the means and standard deviations selected via the user interface retrieved from a memory location at runtime rather than being calculated at runtime. For example, means and standard deviations of all of the available parameters can be compiled in advance and their values stored for access at runtime. An adjusted mean and standard deviation may be determined using one or more factors calculated using the population mean and standard deviation and the means and standard deviations of one or more of the parameters as described previously.

At step 210, a probability distribution is generated by a statistical modeling application using the adjusted mean and standard deviation. The probability distribution depicts a probability that the asset will sell with respect to time. A probability weighted DLOM for the asset is calculated based on the probability distribution as indicated at step 212. The probability weighted DLOM can be determined by, for example, dividing the probability distribution into a plurality of time segments, calculating a period-specific DLOM for each of the time segments, weighting the period-specific DLOM for each segment based on the probability associated with the time segment depicted by the probability distribution, and summing the weighted period-specific DLOMs.

At step 214, the probability weighted DLOM is presented to the user via the user interface 40. A variety of other calculations, such as DLOM calculations by other methods available in the art, may be performed by the computing device 12 and their results presented along with the probability weighted DLOM on the user interface 40. One or more graphics, visualizations, or other representations of the probability distribution, the probability weighted DLOM, or other data may also be presented on the user interface 40. In one embodiment, a purchase or payment from the user is required and/or requested by the user interface 40 before the presentation of the probability weighted DLOM thereon. An additional screen, page, pop-up window or the like may be presented to prompt the user for payment information as known in the art.

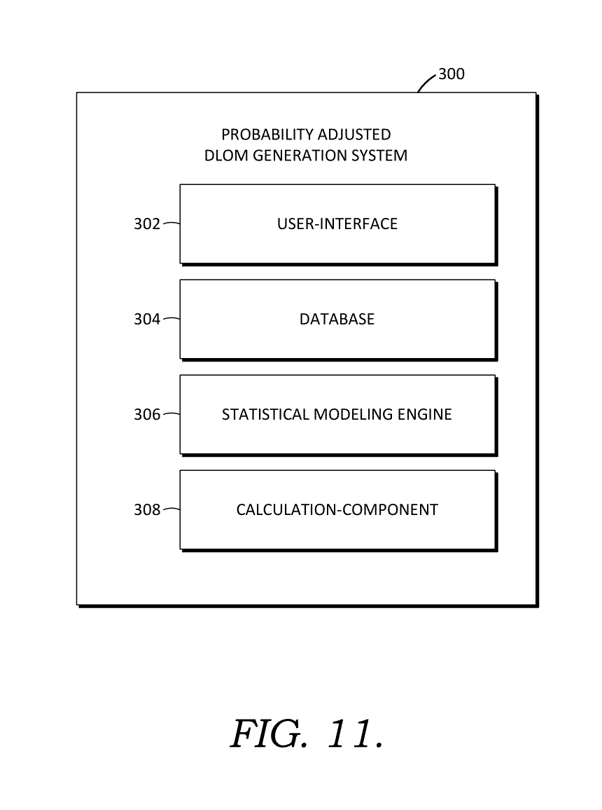

With reference to FIG. 11, a system 300 for providing a probability adjusted discount for lack of marketability for an asset is described in accordance with an embodiment of the invention. The system 300 includes a user interface 302, a database 304, a statistical modeling engine 306, and a calculation-component 308. The user interface 302 may be similar to the user interface 40 described previously above and is presented on a display device, like the display component 26, to prompt a user for inputs and to provide outputs thereto.

The database 304 comprises a non-transitory computer memory or storage (like, for example, the database 18) that includes a plurality of transaction data elements from a plurality of previously completed sales of assets. The database 304 may be provided by a third party or may be resident on the user's computing device or a computing device accessed by the user via a network, e.g. the computing device 12 and the network 16.

The statistical modeling engine 306 may similarly be provided by a third party on a remote computing system that is accessible via a network or may be resident on the user's computing device or a computing device accessed thereby. In one embodiment, the statistical modeling engine 306 comprises one or more components of the Crystal Ball suite of applications provided by Oracle Corporation. The statistical modeling engine 306 is configured to generate a probability distribution depicting the likelihood that an asset will sell with respect to time based on a mean and a standard deviation of transaction periods in which other assets have previously sold. The engine 306 and/or the generation of the probability distribution may be configurable based on a variety of variables including, for example, a number of trials or iterations to be considered by the engine 306, among others.

The calculation-component 308 may comprise the user's computing device or a computing device accessed thereby and is configured to generate a probability weighted DLOM based on the probability distribution returned by the statistical modeling engine 306 using methods as described previously above. In one embodiment, the calculation-component 308 is configured to calculate the probability weighted DLOM in real time or at runtime, e.g. to complete hundreds or thousands of calculations involved in generating the probability weighted DLOM in a time span of less than a few seconds. The calculation-component 308 may also calculate one or more additional data elements such as a DLOM produced using another formula available in the art and/or an adjusted mean and standard deviation for the asset based on the transaction data, among others. In one embodiment, the calculation component 308 calculates and caches a mean and standard deviation for the population and for subsets of the population of transaction data based on one or more parameters; the cached data is then subsequently useable on demand without requiring calculation thereof at runtime.

With reference now to FIGS. 9, 12, and 13, an exemplary application of an embodiment of the invention is described with respect to an illustrative asset comprising a privately held business to be valued. A user interface, such as the user interface 40 is provided to a user via a web-based service that is accessible by the user's computing device. An estimated price volatility of 50% is received as an input along with a selection of a BIZCOMP database from which to obtain transaction data associated with previously sold assets. Parameters indicating that the two-digit SIC code for the business is in the range of 10-14, the listing price of the business falls in the range of $92,000-$109,999, and that the listing date for the business is in March of the year 1999. Subsets of the transactions included in the BIZCOMP database are identified based on each of the parameter values. The subsets may overlap or may be mutually exclusive. Means and standard deviations are determined for the total population and for each of the subsets of the transaction data. And an adjusted mean and standard deviation are determined therefrom using methods described previously above.

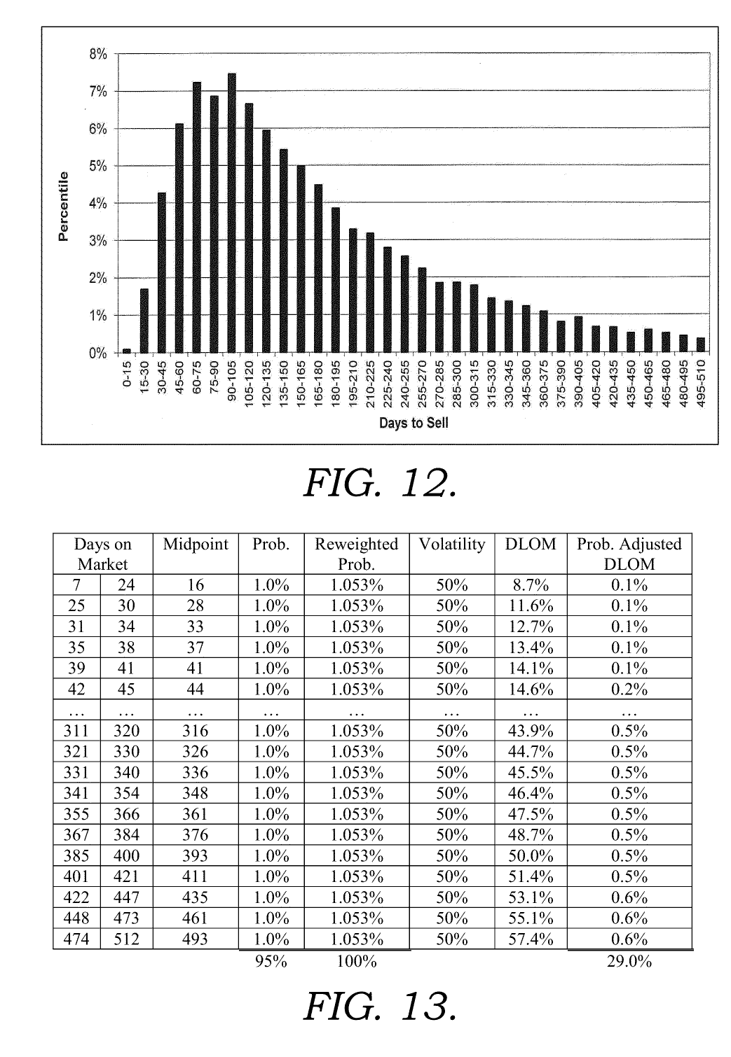

The adjusted mean and standard deviation are provided to the statistical modeling engine to produce a probability distribution depicting the probability that the business will sell with respect to time. A graphical representation of the data representing the probability distribution produced by the statistical modeling engine is depicted in FIG. 12 and FIG. 13 depicts a selection of the data in a table format. An upper bound is placed on the probability distribution at a time or transaction period equal to about 512 days which represents the point at which the asset has a 95% probability of being sold. As depicted in FIG. 12, the curve of the probability distribution appears to be asymptotic as it extends toward very large time values; these large time values may thus be considered to be unlikely and/or irrelevant because assets typically do not require such long transaction periods to sell.

As depicted in FIG. 13, the probability distribution is divided into time segments that correlate with each cumulative percentage point of the probability depicted by the probability distribution. As such, the time segments are not uniform, e.g. do not include an equal amount of time. A midpoint is determined for each time segment however an initial time, ending time, or other time value within the time segment could be employed; the midpoints shown in FIG. 13 may exhibit some rounding error. The probabilities are also reweighted to apply a scale based on 100% rather than the 95% scale that results from applying the statistical modeling engine.

With continued reference to FIG. 13, the previously described formula based on the Longstaff look-back model:

$$DLOM = V ( 2 + \frac{{σ}^{2} T}{2} ) N ( \frac{\sqrt{{σ}^{2} T}}{2} ) + V \sqrt{\frac{{σ}^{2} T}{2 π}} exp ( - \frac{{σ}^{2} T}{8} ) - V$$

is employed along with the estimated price volatility (V) and the midpoint (T) to determine a DLOM for each time segment, e.g. a period-specific DLOM. The period-specific DLOMs are next each multiplied by the respective probabilities (1.053% in this example) associated with each time segment to produce a probability weighted DLOM. The probability weighted DLOMs for all of the time segments are summed to produce a probability weighted DLOM for the asset equal to 29.0%.

As shown in FIG. 10, the resulting probability weighted DLOM, as well as the adjusted mean and the adjusted standard deviation, are provided to the user via the user interface 40. The DLOM calculated using known averaging methods may also be provided to allow the user to compare with the probability weighted DLOM. A graphical representation of the probability distribution like that depicted in FIG. 12 can also be provided on the user interface 40. Other available materials such as reference materials explaining the methodologies used to calculate the probability weighted DLOM or links thereto may also be provided on the user interface 40. The user may be prompted for a payment at any time, including pursuant to a single-user or multiple-user subscription; prior to the computing device making calculations; prior to presentation of the generated data and/or any additional materials to the user; or otherwise.

Many different arrangements of the various components depicted, as well as components not shown, are possible without departing from the scope of the claims below. Embodiments of the technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

1. A computer-implemented method for generating a discount for lack of marketability (DLOM), the method comprising:
storing a population mean transaction period and a population standard deviation of transaction periods of a population of asset sale transactions in a computing device having a processor, the computing device comprising one computing device or a plurality of computing devices communicatively coupled via one or more networks;
transforming the population mean and the population standard deviation into a probability distribution of the probability that an asset representative of the population will sell in an amount of time;
determining a probability weighted DLOM using a formula and the probability distribution.

2. The computer-implemented method of claim 1, further comprising:
determining an adjusted mean and an adjusted standard deviation based on the population mean and the population standard deviation of transaction periods and one or more subset means and subset standard deviations of transaction periods of subsets of the population of asset sale transactions, and
wherein transforming the population mean and population standard deviation comprises transforming the adjusted mean and adjusted standard deviation into the probability distribution of the probability that an asset representative of the population will sell in an amount of time.

3. The computer-implemented method of claim 1, wherein the population of asset sale transactions comprises sale transactions associated with private businesses.

4. The computer-implemented method of claim 3, wherein data elements associated with the population of asset sale transactions include one or more of a listing date, a closing date, an SIC code, and an asking price for each of the transactions in the plurality.

5. The computer-implemented method of claim 2, wherein data elements associated with the one or more subsets of the population of asset sale transactions comprise one or more of an SIC code, an asking price range, a month in which the asset is listed for sale, and a year in which the asset is listed for sale.

6. The computer-implemented method of claim 2, wherein determining the adjusted mean and the adjusted standard deviation further comprises:
receiving a selection of a parameter associated with the asset;
identifying a subset of the transactions in the plurality of transactions associated with the parameter;
determining the subset mean and the subset standard deviation of the transaction periods of the transactions in the subset; and
determining a mean factor and a standard deviation factor by dividing the subset mean and the subset standard deviation by the population mean and population standard deviation respectively.

7. The computer-implemented method of claim 6, further comprising:
determining a second subset mean and standard deviation for transaction periods for a second subset of transactions in the plurality associated with a second parameter; and
multiplying the second subset mean and standard deviation by the mean factor and the standard deviation factor to generate the adjusted mean and the adjusted standard deviation.

8. The computer-implemented method of claim 1, wherein the probability distribution is a natural logarithmic distribution.

9. The computer-implemented method of claim 1, wherein the formula is based on the Longstaff model.

10. The computer-implemented method of claim 1, wherein a user provides a volatility estimate that is input to the formula.

11. The computer-implemented method of claim 1, further comprising:
dividing a time scale of the probability distribution into a plurality of selected time periods, each selected time period having a representative time that is in the selected time period, and each representative time having an associated probability of occurring defined by the probability distribution;
using the formula to determine a period-specific DLOM of the asset for each period based at least on the representative time for each selected time period; and
calculating the probability weighted DLOM for the asset by multiplying the period-specific DLOM for each selected time period by the probability associated with each representative time and summing the products.

12. The computer-implemented method of claim 1, further comprising:
providing a user interface that is presented on a display and includes a field that receives a selection of a parameter and a field that receives a volatility estimate from a user.

13. One or more non-transitory computer-readable media having computer-executable instructions embodied thereon that, when executed by a computing device having a processor, perform a method for generating a discount for lack of marketability (DLOM) for an asset, the method comprising:
presenting a user interface on a display device of a computing device having a processor, the computing device comprising one or more computing devices;
receiving via one or more fields in the user interface at least one parameter for a marketing period associated with the asset;
calculating a population mean and a population standard deviation of transaction time periods;
calculating at least one subset mean and at least one subset standard deviation of transaction time periods for at least one subset of the transactions associated with the at least one parameter;
generating a statistical probability distribution representing a probability that the asset will sell in an amount of time, the probability distribution being at least partially based on the population mean and population standard deviation and the at least one subset mean and the at least one subset standard deviation; and
determining a probability weighted DLOM based on a formula that employs data elements from the probability distribution as inputs thereto.

14. The computer-readable media of claim 13, wherein the one or more computing devices are communicatively coupled via one or more networks.

15. The computer-readable media of claim 13, wherein the user interface further includes a field for receipt of a selection of a database from which data associated with the sold assets is stored.

16. The computer-readable media of claim 13, wherein the at least one parameter includes one or more of an SIC code, an asking price range, a listing month, and a listing year associated with the sale of the asset, and wherein the plurality of transactions for the sold assets comprise sales transactions of private businesses.

17. The computer-readable media of claim 13, wherein the at least one subset mean includes a first subset mean and a second subset mean and the at least one subset standard deviation includes a first subset standard deviation and a second subset standard deviation, and wherein the method further comprises:
determining a mean factor and a standard deviation factor by dividing the first subset mean by the population mean and dividing the first subset standard deviation by the population standard deviation; and
generating an adjusted mean and an adjusted standard deviation by multiplying the second subset mean and the second subset standard deviation by the mean factor and the standard deviation factor respectively, and
wherein the statistical probability distribution is generated based on the adjusted mean and the adjusted standard deviation.

18. The computer-readable media of claim 13, wherein determining the probability weighted DLOM based on the formula that employs data elements from the probability distribution as inputs thereto further comprises:
determining a period-specific DLOM of the asset for each of a plurality of selected time periods within a total transaction period depicted by the probability distribution, a representative time associated with the selected time periods being an input to the formula; and
weighting the period-specific DLOM using the probability of selling the asset in the respective period depicted by the probability distribution.

19. A computer-implemented system for generating a probability adjusted discount for lack of marketability (DLOM) for an asset, the system comprising:
a web-based user interface provided by a computing device having a processor, the user interface having a plurality of fields configured to receive an identification of an estimated marketing period volatility of the asset and at least one parameter associated with a valuation of the asset, and the computing device comprising one or more computing devices communicatively coupled by one or more networks;
a database disposed on one or more non-transitory computer readable media and accessible by the computing device, the database containing transaction data for transactions for the sale of a plurality of asset sale transactions; and
a statistical modeling engine operable by the computing device to transform a mean and a standard deviation into a probability distribution of probabilities of closing a sale of a representative asset with respect to time.

20. The system of claim 19, further comprising:
a calculation-component configured to determine a probability weighted DLOM for the asset based at least partially on the probabilities of closing the sale of the asset depicted by the probability distribution.

21. The system of claim 18, wherein the statistical modeling engine is operable to generate a visualization on the user interface of the probability distribution.

22. The system of claim 20, wherein the calculation-component determines the probability weighted DLOM for the asset by applying a formula based on the Longstaff model to each of a plurality of transaction periods depicted in the probability distribution to generate a plurality of period-specific DLOMs, multiplying the plurality of period-specific DLOMs by the probability associated with each transaction period depicted by the probability distribution, and summing the products.

23. The system of claim 22, wherein the probability distribution is divided into a plurality of time periods, each time period having a midpoint, and each midpoint having an associated probability defined by the probability distribution, the midpoints and their respective probabilities being employed by the calculation-component to determine the period-specific DLOMs.

24. The system of claim 20, wherein the calculation-component limits the time scale of the probability distribution and adjusts the probabilities of the probability distribution below the upper bound to sum to 100%.

25. A computer-implemented method for generating a discount for lack of marketability (DLOM), the method comprising:
receiving by a computing device having a processor, a selection of a parameter associated with an asset, the computing device comprising one or more computing devices;
identifying a subset of transactions associated with the parameter in a population of asset sale transactions;
determining the subset mean and the subset standard deviation of transaction periods of the transactions in the subset; and
determining a mean factor and a standard deviation factor by dividing the subset mean and the subset standard deviation by a population mean and population standard deviation of the population of asset sale transactions, respectively.

26. The computer-implemented method of claim 25, further comprising:
identifying a second subset mean and a second subset standard deviation for transaction periods for a second subset of transactions in the plurality of asset sale transactions, the second subset being associated with a second parameter; and
multiplying the second subset mean and the second subset standard deviation by the mean factor and the standard deviation factor to generate an adjusted mean and an adjusted standard deviation.

27. One or more non-transitory computer-readable media having computer-executable instructions embodied thereon that, when executed by a computing device having a processor, perform a method for generating a discount for lack of marketability (DLOM) for an asset, the method comprising:
receiving a user interface presented on a display device of a computing device having a processor, the computing device comprising one or more computing devices;
inputting via one or more fields in the user interface a selection of at least one parameter, and a marketing period volatility estimate associated with the asset;
triggering the computing device to determine a population mean and a population standard deviation of transaction periods for a plurality of transactions for sold assets, the transaction period being equal to a time period between a listing date and a closing date for a sale of a respective sold asset;
triggering the computing device to determine at least one subset mean and at least one subset standard deviation of transaction periods for at least one subset of the transactions associated with the at least one parameter;
receiving via the display device a representation of a statistical probability distribution representing a probability that the asset will sell in an amount of time, the probability distribution being at least partially based on the population mean and population standard deviation and the at least one subset mean and the at least one subset standard deviation; and
generating, via the computing device, a probability weighted DLOM based on a formula that employs data elements from the probability distribution as inputs to the formula.
